(19) United States
(12) Patent Application Publication
(10) Pub. No.: US 2011/0034601 A1
(43) Pub. Date: Feb. 10, 2011

(54) Polyvinyl Chloride Composition

(75) Inventor: Yen-Kun Lee, Hong Kong (CN)

Correspondence Address: WPAT, PC;INTELLECTUAL PROPERTY ATTORNEYS, 2030 MAIN STREET, SUITE 1300, IRVINE, CA, 92614, US

(73) Assignee: TA YI PLASTIC (H.K.) LIMITED, Hong Kong (CN)

(21) Appl. No.: 12/820,506

(22) Filed: Jun. 22, 2010

(30) Foreign Application Priority Data
Aug. 10, 2009 (CN) 200910161354.3

(51) Int. Cl. C08L 53/00; C08K 3/22

(52) U.S. Cl. 524/271; 525/93; 524/436

(57) ABSTRACT

The present invention relates to a polyvinyl chloride (PVC) composition comprising an alkene-containing resin and a processing modifier. The alkene-containing resin consists of from 17 to 90 PHR of PVC, from 9 to 68 PHR of chlorinated poly(vinyl chloride) (CPVC) and from 10 to 15 PHR of acrylonitrile butadiene styrene (ABS). The processing modifier is selected from the group consisting of petroleum resin, rosin resin, and any combination of them. The PVC composition of the present invention has improved deflection temperature under load and fluidity.

### BACKGROUND OF THE INVENTION

1. Field of the Invention

The present invention relates to a polyvinyl chloride (PVC) composition, particularly a PVC composition having improved deflection temperature under load and fluidity.

2. Description of the Prior Arts

Polyvinyl chloride (PVC) is low cost, has high strength and is easily colored so it is widely used in different applications, such as a building material, vehicles and electronic devices. However, PVC is hard and brittle so its impact resistance, deflection temperature and fluidity are relatively low and accordingly restrict applications of PVC.

It has been found that the impact resistance of PVC can be improved by adding acrylonitrile butadiene styrene (ABS), methacrylate butadiene styrene (MBS), acrylate copolymer (ACR) and chlorinated polyethylene (CPE) to PVC. It is also found that by adding acrylonitrile styrene acrylate (ASA), ABS and chlorinated poly(vinyl chloride) (CPVC) to PVC improves the deflection temperature of PVC. The aforesaid materials added to improve the impact resistance and deflection temperature of PVC will decrease the fluidity of PVC so adding a plasticizer is needed to improve the fluidity of PVC. When the plasticizer is added to PVC, the deflection temperature will undesirably decrease so the obtained PVC composition cannot be used in products having high deflection temperature under load.

To overcome the shortcomings, the present invention provides a PVC composition containing a novel processing modifier to mitigate or obviate the aforementioned problems.

### SUMMARY OF THE INVENTION

A primary objective of the present invention is to provide a polyvinyl chloride (PVC) composition having both improved deflection temperature and fluidity. To achieve the objective, a novel processing modifier is used in place of a conventional plasticizer.

Accordingly, the present invention provides a polyvinyl chloride (PVC) composition, comprising:

an alkene-containing resin consisting of from 17 to 90 PHR of PVC, from 9 to 68 PHR of chlorinated poly(vinyl chloride) (CPVC) and from 10 to 15 PHR of acrylonitrile butadiene styrene (ABS), and

based on the alkene-containing resin, at least 10 PHR of a processing modifier selected from the group consisting of petroleum resin, rosin resin, and any combination thereof.

In one embodiment, based on the alkene-containing resin, the processing modifier is a combination of from 8 to 16 PHR of petroleum resin and from 8 to 16 PHR of rosin resin. Preferably, the petroleum resin is C9 petroleum resin, and the rosin resin is selected from the group consisting of maleic modified rosin resin, rosin glycerin ester, polymerized rosin, terpene rosin, phenolic rosin, hydrogenated rosin, water-white rosin and rosin pentaerythritol ester.

In one embodiment, the processing modifier is a combination of petroleum resin and rosin resin and based on the alkene-containing resin, the PVC composition comprises 78 PHR of PVC, 10 PHR of CPVC, 12 PHR of ABS, 8 PHR of petroleum resin and 8 PHR of rosin resin. Preferably, the petroleum resin is C9 petroleum resin.

In another embodiment, the processing modifier is a combination of petroleum resin and rosin resin and based on the alkene-containing resin, the PVC composition comprises 17 PHR of PVC, 68 PHR of CPVC, 12 PHR of ABS, 15 PHR of C9 petroleum resin and 15 PHR of rosin pentaerythritol ester.

In another embodiment, the processing modifier is a combination of petroleum resin and rosin resin and based on the alkene-containing resin, the PVC composition comprises 76 PHR of PVC, 9 PHR of CPVC, 15 PHR of ABS, 8 PHR of C9 petroleum resin and 8 PHR of rosin pentaerythritol ester.

In another embodiment, based on the alkene-containing resin, the PVC composition of the present invention further comprises from 5 to 8 PHR of a calcium-zinc stabilizer, from 0 to 2 PHR of an organic tin stabilizer, 1 PHR of an internal lubricant, 10 PHR of calcium carbonate, 1 PHR of an external lubricant and 1 PHR of a processing aid. Preferably, based on the alkene-containing resin, the calcium-zinc stabilizer is at an amount of 5 PHR and the organic tin stabilizer is at an amount of 1 PHR.

Preferably, based on the alkene-containing resin, the processing modifier is a combination of 8 PHR of C5 petroleum resin and 8 PHR of rosin pentaerythritol ester.

In another embodiment of the PVC composition, the alkene-containing resin consists of 8 PHR of PVC, 10 PHR of CPVC and 12 PHR of ABS and the processing modifier is a combination of 10 PHR of the petroleum resin or 10 PHR of the rosin resin based on the alkene-containing resin.

By use of the processing modifier of the present invention to replace the conventional plasticizer improves not only the fluidity but also the deflection temperature of PVC so the obtained PVC composition can be used in products having high deflection temperature under load.

Other objectives, advantages and novel features of the invention will become more apparent from the following detailed description.

### DETAILED DESCRIPTION OF THE PREFERRED EMBODIMENTS

The present invention relates to a PVC composition. In the composition, CPVC is used to improve the deflection temperature of PVC and ABS is used to improve the impact resistance of PVC. Further, the petroleum resin and/or the rosin resin are used in place of conventional plasticizer to improve the fluidity of PVC and simultaneously increase the deflection temperature of PVC.

The rosin resins and the petroleum resins raise softening temperature to higher than 80° C. and are compatible with PVC. With use of the aforesaid properties, the rosin resin and the petroleum resin can be used to improve the fluidity of PVC and simultaneously increase the deflection temperature of PVC.

PHR refers to “parts per hundred parts of resin.” In the present invention, all the amounts represented by PHR refers to parts per hundred parts of the alkene-containing resin that consists of ABS, CPVC and PVC. Specifically, the total amount of ABS, CPVC and PVC will be 100 PHR in the present invention. The total amount of ABS, CPVC and PVC is still counted as 100 PHR even it is not 100 PHR. The amounts of other materials represented by PHR are all based on the alkene-containing resin.

The organic tin stabilizer in the present invention can be organic tin thiols or organic tin sulfides. For example, the organic tin stabilizer is methyltin thioester.

The calcium-zinc stabilizer in the present invention can be a stabilizer based on fatty acid calcium salts and fatty acid zinc salts and comprise anti-aging agents and hydrotalcites.

The external lubricant in the present invention can be a polymer. For example, the external lubricant is polyethelyne, poly(ethylene glycol) or methyl methacrylate-butyl acrylate-styrene copolymer.

The internal lubricant in the present invention can be fatty acid esters. For example, the internal lubricant is Glyceryl monostearate (GMS), distearyl phthalate or low molecular fatty acid polyester.

Acrylate can be used as the processing aid in the present invention.

The following examples are provided to furnish additional illustrative disclosure of the present invention. These examples are not intended to limit the scope of that which is regarded as the invention.

### Example 1

### Preparation of PVC Composition of the Present Invention

PVC, CPVC, ABS, calcium-zinc stabilizer, organic tin stabilizer, internal lubricant, external lubricant and processing aid were put into a high-speed mixer. Afterwards, the high-speed mixer was turned on. When the high-speed mixer was running at 600 rpm at 100° C., petroleum resin and rosin resin were added to the mixer. When the high-speed mixer was running at 600 rpm at 110° C., calcium carbonate was added to the mixer. The high-speed mixer was stopped when the temperature reached 135° C. and a mixed PVC composition was obtained.

### Example 2

### Preparation of PVC Specimens for Properties Test

The mixed PVC composition was put into a Φ70 single-screw extruder. In the extruder, the temperature of the feed zone, the middle zone and the extrusion zone were set at 180° C., 195° C. and 185° C. respectively. The PVC composition was extruded by the extruder and cut by a high-speed cutting to obtain a PVC strip.

The PVC strip was cooled and delivered to a dicing cutter to be cut to a granular PVC. Then the granular PVC was made to a PVC sheet by a twin roller. The PVC sheet was put into a molding machine to form a block material with desired thickness. The block material was cut appropriately to prepare specimens for Vicat softening point test and melt index test.

### Example 3

### Properties Test for PVC Composition of the Present Invention

1. Comparison of Processing Modifier of the Present Invention and Conventional Plasticizer

The PVC composition was prepared by the method described in Example 1. Various processing modifiers of the present invention and conventional plasticizers were respectively added to formulations containing the components in specific amounts to obtain the PVC composition. The obtained PVC compositions were prepared to appropriate specimens as described in Examples 2 for Vicat softening point test and melt index test. The components and their amounts in the formulation are shown in Table 1.

TABLE 1
List of the components and their amounts in the formulation

| Component | Amount (PHR) |
|---|---|
| PVC | 78 |
| CPVC | 10 |
| ABS | 12 |
| Calcium-zinc stabilizer | 5 |
| Organic tin stabilizer^{a} | 1 |
| Internal lubricants^{b} | 1 |
| External lubricant^{c} | 1 |
| Calcium carbonate | 10 |
| Processing aid | 1 |

^{a}Methyltin thioester with product name T 191 produced by ARKEMA
^{b}Distearyl phthalate with product name G 60 produced by HENKEL
^{c}PARALOID ™ K-175 produced by ROHM and HAAS

The processing modifiers of the present invention and conventional plasticizers used are shown in Table 2. The Vicat softening point and the melt index measured from the PVC compositions containing different processing modifiers of the present invention or conventional plasticizers are shown in Table 3.

In the present invention, melt index is measured according to ASTM-D1238. Melt index (200° C.×10 Kg) means the melt index is measured at 200° C. with 10 kg loading for 10 minutes. Melt index (210° C.×10 Kg) means the melt index is measured at 210° C. with 10 kg loading for 10 minutes. The Vicat softening point is measured according to ASTM-D1525 with 500 g loading.

TABLE 2
Components and their amounts in the modifiers of the present
invention and in the conventional plasticizers

| | Components and Amounts |
|---|---|
| Modifier A | 8 PHR maleic modified rosin resin and 8 PHR C9 |
| | petroleum resin |
| Modifier B | 8 PHR rosin glycerin ester and 8 PHR C9 petroleum resin |
| Modifier C | 8 PHR polymerized rosin and 8 PHR C9 petroleum resin |
| Modifier D | 8 PHR terpene rosin and 8 PHR C9 petroleum resin |
| Modifier E | 8 PHR phenolic rosin and 8 PHR C9 petroleum resin |
| Modifier F | 8 PHR hydrogenated rosin and 8 PHR C9 petroleum resin |
| Modifier G | 8 PHR water-white rosin and 8 PHR C9 petroleum resin |
| Modifier H | 8 PHR rosin pentaerythritol ester and 8 PHR C9 |
| | petroleum resin |
| Modifier I | 8 PHR rosin pentaerythritol ester and 8 PHR C5 |
| | petroleum resin |
| Modifier J | 16 PHR C9 petroleum resin |
| Modifier K | 10 PHR C9 petroleum resin |
| Modifier L | 12 PHR C9 petroleum resin |
| Modifier M | 14 PHR C9 petroleum resin |
| Modifier N | 10 PHR rosin pentaerythritol ester |
| Modifier O | 12 PHR rosin pentaerythritol ester |
| Modifier P | 14 PHR rosin pentaerythritol ester |
| Plasticizer A | 4 PHR di-isononyl phthalate (DINP) |
| Plasticizer B | 6 PHR DINP |
| Plasticizer C | 8 PHR DINP |
| Plasticizer D | 10 PHR DINP |
| Plasticizer E | 12 PHR DINP |

TABLE 3
The Vicat softening point and the melt index measured from
the PVC compositions having modifiers or plasticizers shown in Table 2

| | Vicat softening point (° C.) | Melt index (200° C. × 10 Kg) |
|---|---|---|
| Modifier A | 96 | 14 |
| Modifier B | 92 | 22 |
| Modifier C | 90 | 15 |
| Modifier D | 87 | 35 |
| Modifier E | 87 | 17 |
| Modifier F | 88 | 26 |
| Modifier G | 88 | 23 |
| Modifier H | 91 | 20 |
| Modifier I | 89 | 39 |
| Modifier J | 89 | 18 |
| Modifier K | 96 | 9 |
| Modifier L | 93 | 11 |
| Modifier M | 95 | 11 |
| Modifier N | 89 | 9 |
| Modifier O | 88 | 12 |
| Modifier P | 89 | 14 |
| Plasticizer A | 80 | 12 |
| Plasticizer B | 75 | 16 |
| Plasticizer C | 71 | 19 |
| Plasticizer D | 70 | 24 |
| Plasticizer E | 67 | 31 |

As shown in Table 3, compared to the PVC compositions having conventional plasticizer, the PVC compositions of the present invention have both good melt index and Vicat softening point higher than 87° C.

2. The Effect of Amounts of CPVC, ABS and Modifier on PVC Properties

Different amounts of CPVC, ABS, C9 petroleum resin and rosin pentaerythritol ester were used to prepare PVC compositions of the present invention. The obtained PVC compositions were processed for Vicat softening point test and melt index test. The amount of each component used in different compositions and the Vicat softening point and melt index measured are shown in Table 4.

TABLE 4
The amounts of components, the Vicat softening
point and melt index of the PVC compositions

| | Composition | Composition | Composition | Composition | Composition |
|---|---|---|---|---|---|
| Component | A | B | C | D | E |
| PVC (PHR) | 78 | 17 | 76 | 17 | 90 |
| CPVC (PHR) | 10 | 68 | 9 | 68 | 0 |
| ABS (PHR) | 12 | 12 | 15 | 12 | 10 |
| C9 petroleum resin | 8 | 15 | 8 | 8 | 0 |
| (PHR) | | | | | |
| rosin pentaerythritol | 8 | 15 | 8 | 8 | 16 |
| ester (PHR) | | | | | |
| Calcium-zinc | 5 | 8 | 5 | 8 | 5 |
| stabilizer (PHR) | | | | | |
| Organic tin | 1 | 2 | 1 | 2 | 0 |
| stabilizer (PHR) | | | | | |
| Internal lubricant | 1 | 1 | 1 | 1 | 1 |
| (PHR) | | | | | |
| External lubricant | 1 | 1 | 1 | 1 | 1 |
| (PHR) | | | | | |
| ACR processing | 1 | 1 | 1 | 1 | 1 |
| aid (PHR) | | | | | |
| Calcium carbonate | 10 | 10 | 10 | 10 | 10 |
| (PHR) | | | | | |
| Vicat softening | 91 | 107 | 93 | 108 | 89 |
| point (° C.) | | | | | |
| Melt index | 20 | 10 | 16 | 0 | 21 |
| (200° C. × 10 Kg) | | | | | |
| Melt index | Not | 27 | Not | 1.8 | Not |
| (210° C. × 10 Kg) | determined | | determined | | determined |

As shown in Table 4, increasing ABS and CPVC can obviously improve the Vicat softening point but undesirably lower the melt index. By increasing C9 petroleum resin and rosin pentaerythritol ester along with raising the processing temperature, as the results of compositions B and D, high Vicat softening point and good melt index were obtained so the processing fluidity of the PVC composition was improved. In addition, satisfied melt index were obtained at 200° C. for compositions A, C and E so the melt index at 210° C. was not measured for them.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A polyvinyl chloride (PVC) composition comprising:
an alkene-containing resin consisting of from 17 to 90 PHR of PVC, from 9 to 68 PHR of chlorinated poly(vinyl chloride) (CPVC) and from 10 to 15 PHR of acrylonitrile butadiene styrene (ABS), and
based on the alkene-containing resin, at least 10 PHR of a processing modifier selected from the group consisting of petroleum resin, rosin resin, and any combination thereof.

2. The composition of claim 1, wherein the processing modifier is a combination of from 8 to 16 PHR of petroleum resin and from 8 to 16 PHR of rosin resin.

3. The composition of claim 2, wherein the petroleum resin is C9 petroleum resin and the rosin resin is selected from the group consisting of maleic modified rosin resin, rosin glycerin ester, polymerized rosin, terpene rosin, phenolic rosin, hydrogenated rosin, water-white rosin and rosin pentaerythritol ester.

4. The composition of claim 2, based on the alkene-containing resin, comprising 78 PHR of PVC, 10 PHR of CPVC, 12 PHR of ABS, 8 PHR of petroleum resin and 8 PHR of rosin resin.

5. The composition of claim 3, based on the alkene-containing resin, comprising 78 PHR of PVC, 10 PHR of CPVC, 12 PHR of ABS, 8 PHR of C9 petroleum resin and 8 PHR of rosin resin.

6. The composition of claim 3, wherein the rosin resin is rosin pentaerythritol ester and the composition comprises 17 PHR of PVC, 68 PHR of CPVC, 12 PHR of ABS, 15 PHR of C9 petroleum resin and 15 PHR of rosin pentaerythritol ester based on the alkene-containing resin.

7. The composition of claim 3, wherein the rosin resin is rosin pentaerythritol ester and the composition comprises 76 PHR of PVC, 9 PHR of CPVC, 15 PHR of ABS, 8 PHR of C9 petroleum resin and 8 PHR of rosin pentaerythritol ester based on the alkene-containing resin.

8. The composition of claim 2, further comprising from 5 to 8 PHR of a calcium-zinc stabilizer, from 0 to 2 PHR of an organic tin stabilizer, 1 PHR of an internal lubricant, 10 PHR of calcium carbonate, 1 PHR of an external lubricant and 1 PHR of a processing aid.

9. The composition of claim 5, further comprising from 5 to 8 PHR of a calcium-zinc stabilizer, from 0 to 2 PHR of an organic tin stabilizer, 1 PHR of an internal lubricant, 10 PHR of calcium carbonate, 1 PHR of an external lubricant and 1 PHR of a processing aid.

10. The composition of claim 6, further comprising from 5 to 8 PHR of a calcium-zinc stabilizer, from 0 to 2 PHR of an organic tin stabilizer, 1 PHR of an internal lubricant, 10 PHR of calcium carbonate, 1 PHR of an external lubricant and 1 PHR of a processing aid.

11. The composition of claim 7, further comprising from 5 to 8 PHR of a calcium-zinc stabilizer, from 0 to 2 PHR of an organic tin stabilizer, 1 PHR of an internal lubricant, 10 PHR of calcium carbonate, 1 PHR of an external lubricant and 1 PHR of a processing aid.

12. The composition of claim 9, wherein the calcium-zinc stabilizer is at an amount of 5 PHR and the organic tin stabilizer is at an amount of 1 PHR.

13. The composition of claim 2, wherein the petroleum resin is C5 petroleum resin at an amount of 8 PHR and the rosin resin is rosin pentaerythritol ester at an amount of 8 PHR.

14. The composition of claim 1, wherein the processing modifier is the petroleum resin at an amount of 10 PHR and the alkene-containing resin consists of 78 PHR of PVC, 10 PHR of CPVC and 12 PHR of ABS.

15. The composition of claim 1, wherein the processing modifier is the rosin resin at an amount of 10 PHR and the alkene-containing resin consists of 78 PHR of PVC, 10 PHR of CPVC and 12 PHR of ABS.
